(19) United States
(12) Patent Application Publication
(10) Pub. No.: US 2024/0247487 A1
(43) Pub. Date: Jul. 25, 2024

(54) VACUUM INSULATED ENCLOSURE COMPONENTS

(71) Applicant: Boxabl Inc., North Las Vegas, NV (US)

(72) Inventors: Paolo Tiramani, Las Vegas, NV (US); Galiano Tiramani, Las Vegas, NV (US); Kyle Denman, North Las Vegas, NV (US)

(73) Assignee: Boxabl Inc., North Las Vegas, NV (US)

(21) Appl. No.: 18/419,934

(22) Filed: Jan. 23, 2024

Related U.S. Application Data
(60) Provisional application No. 63/440,797, filed on Jan. 24, 2023.

(51) Int. Cl. E04C 2/36; B32B 3/12; B32B 5/18; B32B 9/04; B32B 13/02; B32B 13/04

(52) U.S. Cl. CPC E04C 2/365; B32B 3/12; B32B 5/18; B32B 9/046; B32B 13/02; B32B 13/045; B32B 2250/40; B32B 2307/304; B32B 2607/00

(57) ABSTRACT

An enclosure component for a building structure including a core layer having a planar vacuum panel assembly with a first face and an opposed second face is provided. The vacuum panel assembly includes a honeycomb core with two opposed planar surfaces, and with an impermeable sheet bonded to each planar surface of the honeycomb core to seal the honeycomb core, and with air being at least partly evacuated from the honeycomb core prior to sealing to reduce heat transmission across the honeycomb core.

### CROSS-REFERENCE TO RELATED APPLICATIONS

This application claims the benefit of U.S. Provisional Patent Application No. 63/440,797, which was filed on Jan. 24, 2023. The entire content of the foregoing provisional application is incorporated herein by reference.

### FIELD OF THE INVENTION

The inventions herein relate to structures, such as dwellings and other buildings for residential occupancy, commercial occupancy and/or material storage, and to components for such structures.

### BACKGROUND

### Description of the Related Art

In the field of residential housing, the traditional technique for building homes is referred to as “stick-built” construction, where a builder constructs housing at the intended location using in substantial part raw materials such as wooden boards, plywood panels, and steel columns. The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like, in an effort to reduce costs. In this regard, significant advancements are embodied in the BOXABL® foldable transportable dwelling unit, which consists of a number of enclosure components (four wall components, a floor component and a roof component), and portions thereof, which are dimensioned, positioned and folded together to form a compact shipping module 15, as shown in FIG. 1A. The enclosure components and enclosure component portions are dimensioned so that the shipping module 15 is within applicable highway dimensional restrictions. As a result, shipping module 15 can be transported over a limited access highway more easily, and with appropriate trailering equipment, allowing for transportation to occur without the need for oversize load permits. Thus, the basic components of structure 150 can be manufactured in a factory, positioned and joined together to form the shipping module 15, and the module 15 can then be transported to the desired site for the structure 150, where the components can be readily deployed (e.g., unfolded) to yield a relatively finished structure 150, which is shown in FIG. 1B.

### SUMMARY OF THE INVENTION

The present invention constitutes an advancement in enclosure component design that reduces the heat transmission through the floor, roof and wall components of a dwelling unit.

In one aspect, the present invention is directed to an enclosure component for a building structure, where the enclosure component has a thickness and includes a first surface layer having a first face and an opposed second face; and a core layer having a first face, an opposed second face, a first edge, an opposed second edge, a third edge separating the first and second edges and an opposed fourth edge separating the first and second edges. The first and second edges each have a same/equal first linear dimension, and the third and fourth edges each have a same/equal second linear dimension. The core layer has a planar vacuum panel assembly that includes a honeycomb core with two opposed planar surfaces, and with an impermeable sheet bonded to each planar surface of the honeycomb core to seal the honeycomb core. Air is at least partly evacuated from the honeycomb core prior to sealing to reduce heat transmission across the honeycomb core. The enclosure component additionally includes a second surface layer having a first face and an opposed second face, with the second face of the first surface layer being bonded to the first face of the core layer, and the first face of the second surface layer being bonded to the second face of the core layer.

In some embodiments, the vacuum panel assembly can include a planar first foam panel bonded to the first face of the vacuum panel assembly. In some embodiments, the vacuum panel assembly can include a planar second foam panel bonded to the second face of the vacuum panel assembly.

In some embodiments, the honeycomb core can include a structure including a plurality of honeycomb-shaped openings extending through the honeycomb core between the two opposed planar surfaces. The honeycomb-shaped openings define a hollow interior space of the honeycomb core capable of receiving the air therein. In such embodiments, the air is at least partially evacuated from the hollow interior space of the honeycomb-shaped openings prior to sealing to reduce the heat transmission across the honeycomb core. In some embodiments, the honeycomb core can include a plurality of elongated elements each defining a honeycomb-shaped configuration. In such embodiments, the plurality of elongated elements can be bonded to each other in an orientation in which a central longitudinal axis of the elongated elements are aligned in a parallel manner.

In one aspect, the present invention is directed to an enclosure component for a building structure. The enclosure component has a thickness and includes a first surface layer having a first face and an opposed second face. The enclosure component includes a core layer having a first face, an opposed second face, a first edge, an opposed second edge, a third edge separating the first and second edges and an opposed fourth edge separating the first and second edges. The enclosure component includes a second surface layer having a first face and an opposed second face. The first and second edges each have a same/equal first linear dimension, and the third and fourth edges each have a same/equal second linear dimension. The core layer includes a first planar vacuum panel assembly bonded to a first face of a foam panel and a second planar vacuum panel assembly bonded to a second face of the foam panel opposed to the first face, each of the first and second planar vacuum panel assemblies including a honeycomb core with two opposed planar surfaces, and with an impermeable sheet bonded to each of the two opposed planar surfaces of the honeycomb core to seal the honeycomb core, and with air being at least partly evacuated from the honeycomb core prior to sealing to reduce thermal transmission across the honeycomb core. The second face of the first surface layer is bonded to the first face of the core layer, and the first face of the second surface layer is bonded to the second face of the core layer.

These and other aspects of the present inventions are described in the drawings annexed hereto, and in the description of the preferred embodiments and claims set forth below.

### BRIEF DESCRIPTION OF THE DRAWINGS

FIG. 1A is a perspective view of a folded building structure (a shipping module), and FIG. 1B is a perspective view of an unfolded building structure.

FIG. 2 is a top schematic view of the structure shown in FIG. 1B.

FIG. 3 is an end view of a shipping module as shown in FIG. 1A, from which is formed the structure shown in FIG. 1B.

FIG. 4 is an exploded side view of the laminate structure design of the present inventions.

FIG. 5A is a perspective view of a vacuum panel and a first embodiment of the vacuum panel assembly of the present invention.

FIGS. 5B, 5C and 5D are each a side view of second, third and fourth embodiments, respectively, of the vacuum panel assembly of the present invention.

### DETAILED DESCRIPTION OF THE PREFERRED EMBODIMENTS

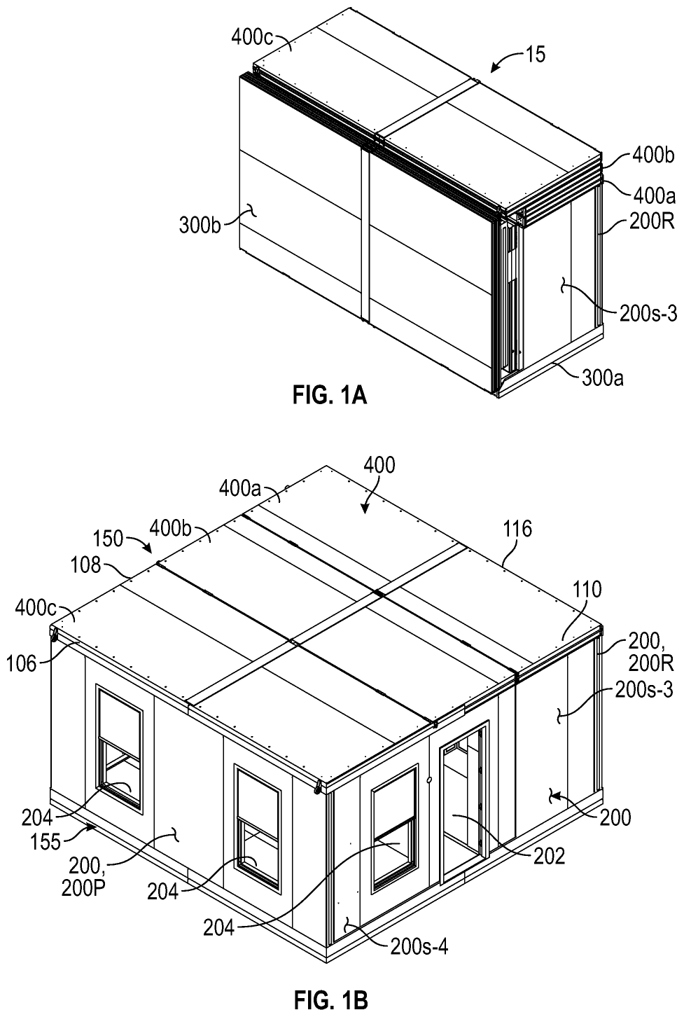

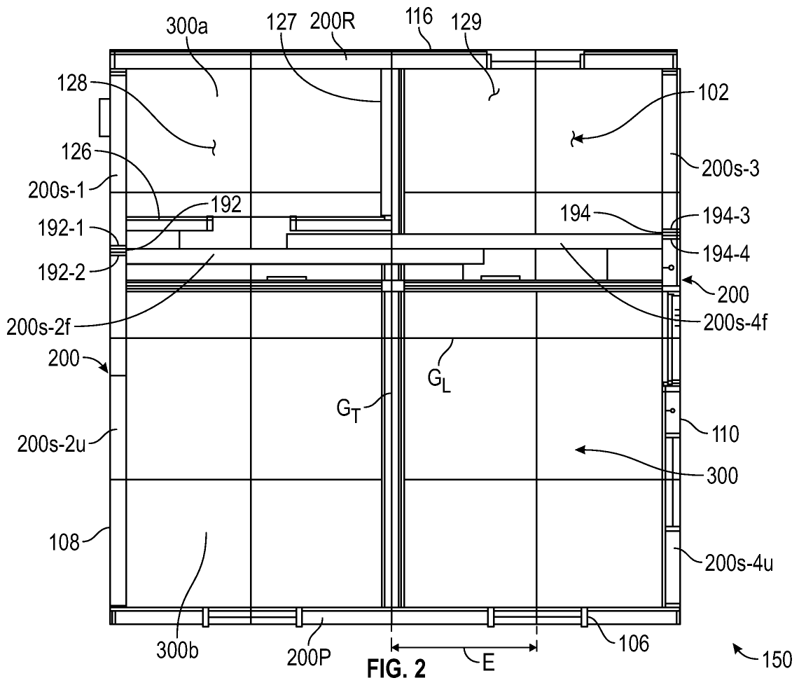

An embodiment of the foldable, transportable structure 150 in which the inventions disclosed herein can be implemented as depicted in FIGS. 1A-3. When fully unfolded, as exemplified by FIG. 1B, structure 150 has a rectangular shape made of three types of generally planar and rectangular enclosure components 155. The three types of enclosure components 155 include a wall component 200, a floor component 300, and a roof component 400. As shown in FIGS. 1A, 1B and 2, the perimeter of structure 150 is defined by first longitudinal edge 106, first transverse edge 108, second longitudinal edge 116 and second transverse edge 110. For convenience, a direction parallel to first longitudinal edge 106 and second longitudinal edge 116 may be referred to as the “longitudinal” direction, a direction parallel to first transverse edge 108 and second transverse edge 110 may be referred to as the “transverse” direction; and a direction parallel to the vertical direction in FIG. 1B may be referred to as the “vertical” direction. Structure 150 as shown includes one floor component 300, one roof component 400 and four wall components 200; although it should be understood that the present inventions are applicable to structures having other configurations as well. The embodiment of structure 150 shown in FIG. 1B is substantially square in shape, e.g., approximately 19 feet (5.79 m) by 19 feet (5.79 m), although embodiments of the structure 150 can have different dimensions.

FIG. 2 shows a top schematic view of structure 150 shown in FIG. 1B, and includes a geometrical orthogonal grid, which is used to assist in the lay-out and assembly of the elements forming structure 150, as well as for clarity of explaining the dimensional relationships among its enclosure components 155. The basic length used for dimensioning is indicated as “E” in FIG. 2; the orthogonal grid overlaid in FIG. 2 is 4E long and 4E wide; notably, the entire structure 150 preferably is bounded by this 4E by 4E orthogonal grid. In the embodiment of structure 150 shown in FIG. 2, dimension “E” is 57 inches (144.8 cm), although embodiments of the structure 150 can have different “E” dimensions.

### Enclosure Component (155): General Description

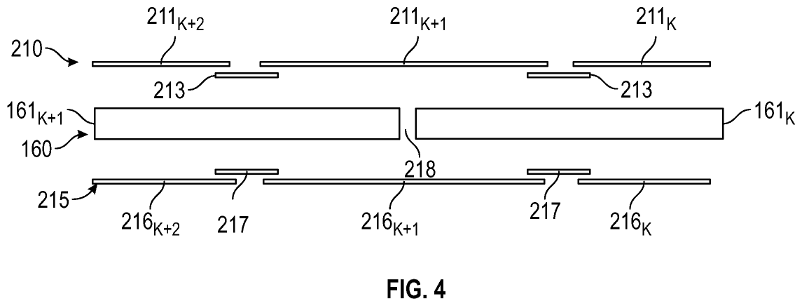

The enclosure components 155 of the present invention can be fabricated using a multi-layered, laminate design generally shown in FIG. 4. Principal elements of this multi-layered, laminate design include a core layer 160, a first surface layer 210, and a second surface layer 215.

Referring to FIG. 4, first surface layer 210 includes two or more planar rectangular first surface panels 211, m in number, where the ith first surface panel 211 is represented by 211ᵢ, and i=1, 2, . . . m. In the case where i≥2, m number of first surface panels 211 are arranged in a side-by-side, contacting relationship (first surface panel 211ₖ, first surface panel 211ₖ₊₁, where 1<k≤m) to form a first surface layer 210 of arbitrary length. An elongate planar rectangular joinder spline 213 at least partially overlaps the kth first surface panel 211ₖ and at least partially overlaps the adjacent k+1 th surface panel 211ₖ₊₁. Joinder spline 213 is shown edge-on in FIG. 4. Each joinder spline 213 underlies a narrow portion of each of the adjacent first surface panels 211ₖ, 211_{k +1}. First surface panels 211 can be for example fiber cement board or magnesium oxide (MgO) board. The joinder splines 213 can be steel strip stock. Joinder splines 213 can be fastened to first surface panels 211 by adhesive, mechanical fasteners or a combination thereof. Joinder splines 213 are fastened to the bottom or inner facing surface of first surface panels 211 such that in the assembled configuration, the top or outer facing surface of first surface panels 211 is substantially flat or planar. Joinder splines 213 are therefore positioned between first surface panels 211 and core layer 160.

Second surface layer 215 has a construction similar to first surface layer 210. In particular, second surface layer 215 includes two or more planar rectangular second surface panels 216, n in number, where the ith second surface panel 215 is represented by 215ᵢ, and i=1, 2, . . . n. In the case where i≥2, n number of second surface panels 216 are arranged in a side-by-side, contacting relationship (second surface panel 216ₖ, second surface panel 216ₖ₊₁, where 1<k≤n) to form a second surface layer 215 of arbitrary length. An elongate planar rectangular joinder spline 217 at least partially overlaps the kth second surface panel 216ₖ and at least partially overlaps the adjacent k+1th second surface panel 216ₖ₊₁. Joinder spline 217 in the described embodiment is the same as joinder spline 213 (but need not be), and is also shown edge-on in FIG. 4. Each joinder spline 217 underlies a narrow portion of each of the adjacent second surface panels 216ₖ, 216ₖ₊₁. Second surface panels 216 can be for example fiber cement board or magnesium oxide (MgO) board. The joinder splines 217 can be steel strip stock. Joinder splines 217 can be fastened to second surface panels 216 by a suitable adhesive, preferably a polyurethane based construction adhesive, by mechanical fasteners, or by a combination thereof. Joinder splines 217 are fastened to the top or inner facing surface of second surface panels 216 such that in the assembled configuration, the bottom or outer facing surface of second surface panels 216 is substantially flat or planar. Joinder splines 217 are therefore positioned between second surface panels 216 and core layer 160.

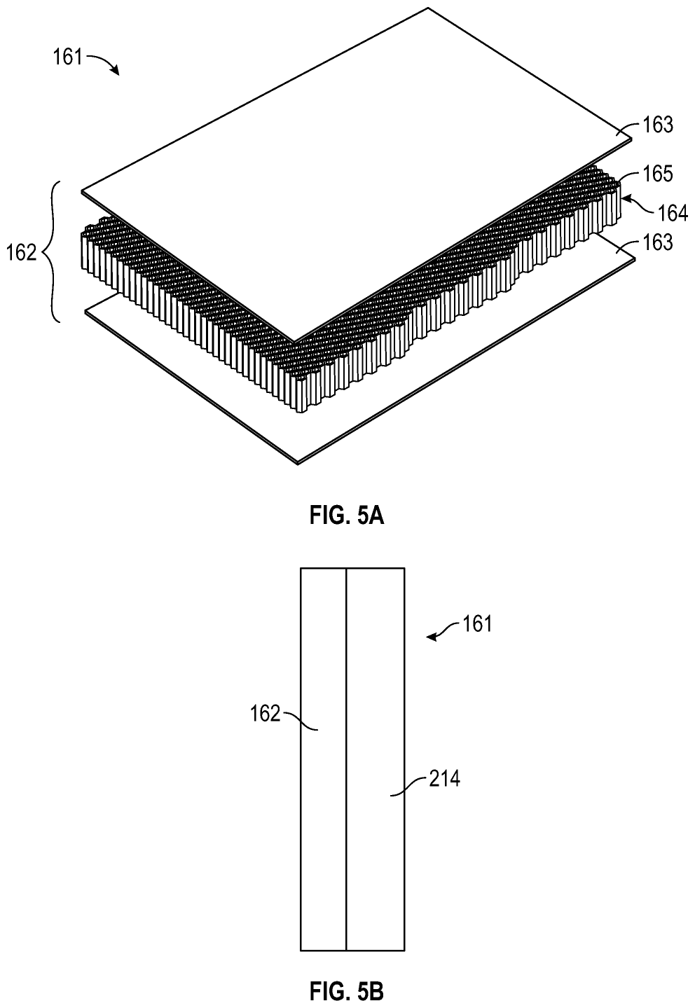

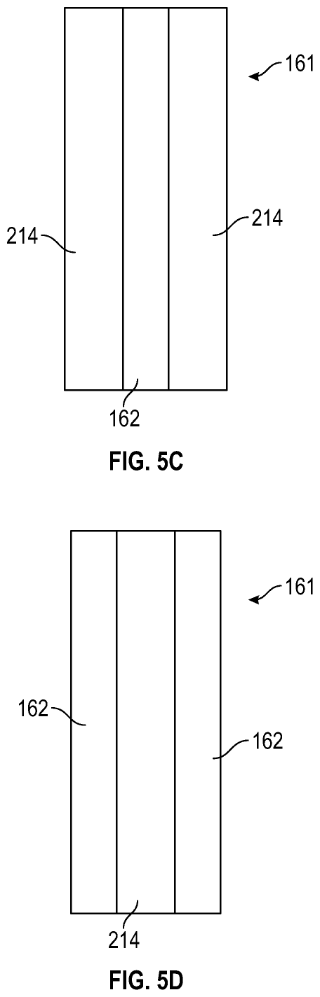

Core layer 160 shown in FIG. 4 is sandwiched between first surface layer 210 and second surface layer 215. Core layer 160 includes one or more vacuum panel assemblies 161 (see, e.g., FIGS. 5A-5D), p in number, where the ith vacuum panel assembly 161 is represented by 161ᵢ, and i=1, 2, . . . p. In the case where i≥2, p number of vacuum panel assemblies 161 are arranged in a side-by-side, contacting relationship (vacuum panel assembly 161ₖ, vacuum panel assembly 161ₖ₊1, where 1<k≤p) to form a planar core layer 160 of arbitrary length, collectively presenting a planar first face and an opposing planar second face. The first face of core layer 160 is bonded to first surface layer 210 using for example a suitable adhesive, preferably a polyurethane based construction adhesive, and the second face of core layer 160 is bonded to second surface layer 215 using for example a suitable adhesive, preferably a polyurethane based construction adhesive. There is a seam 218 between adjacent vacuum panel assemblies 161.

FIG. 5A shows one embodiment of a vacuum panel assembly 161 usable to form the core layer 160 of FIG. 4. In a first embodiment, shown in FIG. 5A, vacuum panel assembly 161 includes a vacuum panel 162, which includes a honeycomb core 164 with an impermeable sheet 163 bonded to each surface of core 164 to seal the honeycomb core 164 therebetween. The honeycomb core 164 includes multiple elongated elements 165, each of which defines a honeycomb cross-section. Each elongated element 165 includes a wall forming the honeycomb configuration, and an inner hollow space extending from a top opening to a bottom opening of the elongated element 165. The elongated element 165 includes a central, longitudinal axis extending parallel to the vertical walls. The elongated elements 165 are bonded together to define an array of honeycomb configured elongated elements 165 that collectively define the honeycomb core 164. The number of elongated elements 165 bonded together and/or the size of the honeycomb core 164 is selected to match or substantially match the surface area defined by the impermeable sheets 163 bonded to opposing sides of the honeycomb core 164.

During fabrication of the panel 162, the air is at least partly evacuated from core 164 (e.g., the hollow spaces within the honeycomb-shaped openings of the elements 165) prior to sealing of the honeycomb core 164 by sheets 163 to reduce the heat transmission across the core 164. For example, one sheet 163 can be bonded to the core 164, air can be at least partially evacuated from the hollow spaces within the core 164, and the second sheet 163 can be bonded to the core 164 to maintain the hollow spaces within the core 164 at least partially evacuated of air. In some embodiments, bonding of the second sheet 163 can be performed immediately after the air evacuation to ensure that sealing of the core 164 is achieved without allowance of air passage therein. This results in the hollow spaces of the honeycomb core 164 being partially under vacuum after sealing. For example, the hollow spaces of the honeycomb core 164 can be at least partly evacuated such that the pressure within the honeycomb core 164 is less than atmospheric pressure.

In a second embodiment, shown in FIG. 5B, vacuum panel assembly 161 includes a vacuum panel 162 bonded to a face of foam panel 214. For example, the foam panel 214 can be bonded to one of the sheets 163.

In a third embodiment, shown in FIG. 5C, vacuum panel assembly 161 includes a vacuum panel 162 with a foam panel 214 bonded to each of the two faces of vacuum panel 162. For example, the foam panel 214 can be bonded to each of the sheets 163.

In a fourth embodiment, shown in FIG. 5D, vacuum panel assembly 161 includes a foam panel 214 with a vacuum panel 162 bonded to each of the two faces of foam panel 214. For example, the sheets 163 of the respective vacuum panels 162 can be bonded to the opposing faces of the foam panel 214 such that the foam panel 214 is sandwiched between the vacuum panels 162.

### A. Enclosure Component Exterior Edge Reinforcement

With reference again to FIGS. 1A-4, the exterior edges of each enclosure component 155 (i.e., the edges that define the perimeter of enclosure component 155) can be provided with exterior edge reinforcement, as desired. Exterior edge reinforcement generally includes an elongate, rigid member which can protect foam panel material that would otherwise be exposed at the exterior edges of enclosure components 155. Exterior edge reinforcement can be fabricated from one or more of laminated strand lumber board, wooden board, C-channel extruded aluminum or steel, or the like, and is generally secured to the exterior edges of enclosure component 155 with fasteners, such as screw or nail fasteners, and/or adhesive.

### B. Enclosure Component Partitioning

Enclosure components 155 in certain instances are partitioned into enclosure component portions to facilitate forming a compact shipping module 15. In those instances where an enclosure component 155 is partitioned into enclosure component portions, any exterior edge reinforcement on the exterior edges defining the perimeter of the enclosure component is segmented as necessary between or among the portions.

The enclosure component portions can be joined by hinge structures or mechanisms to permit the enclosure component portions to be “folded” and thereby contribute to forming a compact shipping module 15.

### C. Enclosure Component Interior Edge Reinforcement

An enclosure component 155 partitioned into enclosure component portions will have interior edges. There will be two adjacent interior edges for each adjacent pair of enclosure component portions. Such interior edges can be provided with interior edge reinforcement. Similar to exterior edge reinforcement, such interior edge reinforcement generally includes an elongate, rigid member which can protect foam panel material that would otherwise be exposed at the interior edges of enclosure components 155. Interior edge reinforcement can be fabricated from one or more of laminated strand lumber board, wooden board, C-channel extruded aluminum or steel, or the like, and is generally secured to the interior edges of enclosure component 155 with fasteners, such as screw or nail fasteners, and/or adhesive.

### D. Enclosure Component Sealing Systems

Structure 150 includes a number of wall, floor and roof components with abutting or exposed exterior edges, as well as a number of partitioned wall, floor and roof components with interior edges. In this regard, sealing structures can be utilized, with the objective to limit or prevent the ingress of rain water, noise and outside air across these exterior and interior edges into the interior of structure 150.

Particular sealing structures for accomplishing the foregoing objective are described in, e.g., U.S. Non-Provisional patent application Ser. No. 17/504,883, filed on Oct. 19, 2021, entitled “Sheet/Panel Design for Enclosure Component Manufacture”, and in PCT Patent Application No. PCT/US21/56415, entitled “Enclosure Component Sealing Systems,” filed on Oct. 25, 2021. The contents of U.S. Non-Provisional patent application Ser. No. 17/504,883, filed on Oct. 19, 2021, entitled “Sheet/Panel Design for Enclosure Component Manufacture”, are hereby incorporated by reference as if fully set forth herein, particularly including the sealing systems described for example at ¶¶ 0083-0170 and depicted in FIGS. 10-20 thereof, and also including the exemplary placements for such sealing systems described in ¶¶ 0171-0177 and depicted in FIGS. 21A-21B thereof. The contents of PCT Patent Application No. PCT/US21/56415, entitled “Enclosure Component Sealing Systems,” filed on Oct. 25, 2021, are also incorporated by reference as if fully set forth herein, particularly including the sealing systems described for example at ¶¶ 0080-0167 and depicted in FIGS. 9-20 thereof, and also including the exemplary placements for such sealing systems described in ¶¶ 0168-0174 and depicted in FIGS. 8A-8B thereof.

### E. Enclosure Component Load Transfer

In the case of enclosure components 155, it is necessary to transfer the loads imposed on their surfaces to their exterior edges, where those loads can be transferred either to or through adjoining walls, or to the building foundation. For enclosure components 155 that are horizontally oriented when in use (floor component 300 and roof component 400), such loads include the weight of equipment, furniture and people borne by their surfaces, as well as vertical seismic loads. For enclosure components that are vertically oriented when in use (wall component 200), such loads include those arising from meteorological conditions (hurricanes, tornadoes, etc.) and human action (vehicle and other object impacts).

For this purpose, multi-layered, laminate design shown in FIG. 4 will function to transfer the loads described above. To add additional load transfer capability, structural members, such as beams and/or joists, can be utilized within the perimeter of the enclosure components 155, as is deemed appropriate to the specific design of structure 150 and the particular enclosure component 155, to assist in the transfer of loads to the exterior edges. Particular embodiments of such structural members which can be used in floor components 300 and roof components 400, which also incorporate hinge structures, are described in U.S. Non-Provisional patent application Ser. No. 17/527,520 entitled “Folding Beam Systems”, filed Nov. 16, 2021. The contents of U.S. Non-Provisional patent application Ser. No. 17/527,520 entitled “Folding Beam Systems”, filed Nov. 16, 2021, are incorporated by reference as if fully set forth herein, particularly the description of the construction of hinge assembly 329A and its hinge assembly portions 330A set forth for example in ¶¶ 0075-0087 and in FIGS. 9-12 and 13C-13E thereof, the description of the construction of hinge assembly 429B and its hinge assembly portions 430B set forth for example in ¶¶ 00106-00118 and in FIGS. 16-19 and 24A thereof, and the description of the construction of hinge assembly 429C and its hinge assembly portions 430C set forth for example in ¶¶ 00119-00126 and in FIGS. 20-23 and 24A-24B thereof.

### Wall Component (200)

Typically, structure 150 will utilize four wall components 200, with each wall component 200 corresponding to an entire wall of structure 150.

### A. General Description

Wall component 200 has a generally rectangular perimeter. As shown in FIG. 1B, wall components 200 have plural apertures, specifically a door aperture 202, which has a door frame and door assembly, and plural window apertures 204, each of which has a window frame and a window assembly. The height and length of wall components 200 can vary in accordance with design preference, subject as desired to the dimensional restrictions applicable to transport, described above. In this disclosure, structure 150 is fashioned with all sides of equal length; accordingly, its first and second longitudinal edges 106 and 116, and its first and second transverse edges 108 and 110, are all of equal length. It should be understood however, that the inventions described herein are applicable to structures having other dimensions, such as where two opposing wall components 200 are longer than the other two opposing wall components 200.

### B. Partitioned Wall Components

Referring to FIG. 2, structure 150 has two opposing partitioned wall components 200, generically denominate 200s. One of the two opposing partitioned wall components 200s includes first wall portion 200s-1 and second wall portion 200s-2, and the other of the two opposing partitioned wall components 200s includes third wall portion 200s-3 and fourth wall portion 200s-4. Each of wall portions 200s-1, 200s-2, 200s-3 and 200s-4 has a generally rectangular planar structure. As shown in FIG. 2, the interior vertical edge 192-1 of wall portion 200s-1 is proximate to a respective interior vertical edge 192-2 of wall portion 200s-2, and the interior vertical edge 194-3 of wall portion 200s-3 is proximate a respective interior vertical wall edge 194-4 of wall portion 200s-4.

Referring again to FIG. 2, first wall portion 200s-1 is fixed in position on floor portion 300a proximate to first transverse edge 108, and third wall portion 200s-3 is fixed in position on floor portion 300a, opposite first wall portion 200s-1 and proximate to second transverse edge 110. First wall portion 200s-1 is joined to second wall portion 200s-2 with a hinge structure that permits wall portion 200s-2 to pivot about vertical axis 192 between a folded position and an unfolded position, and third wall portion 200s-3 is joined to fourth wall portion 200s-4 with a hinge structure to permit fourth wall portion 200s-4 to pivot about vertical axis 194 between a folded position and an unfolded position.

Notably, first wall portion 200s-1 is greater in length (the dimension in the transverse direction) than the length of third wall portion 200s-3 by a distance approximately equal to the thickness of wall component 200, and second wall portion 200s-2 is shorter in length than the length of fourth wall portion 200s-4 by a distance approximately equal to the thickness of wall component 200. Furthermore, wall portion 200s-1 and wall portion 200s-3 are each shorter in length (the dimension in the transverse direction) than the dimension of floor portion 300a in the transverse direction. Dimensioning the lengths of wall portions 200s-1, 200s-2, 200s-3 and 200s-4 in this manner permits wall portions 200s-2 and 200s-4 to nest against each other in an overlapping relationship when in an inwardly folded position. In this regard, FIG. 2 depicts wall portions 200s-2 and 200s-4 both in their unfolded positions, where they are labelled 200s-2u and 200s4-u respectively, and FIG. 2 also depicts wall portions 200s-2 and 200s-4 both in their inwardly folded positions, where they are labelled 200s-2f and 200s4-f respectively. When wall portions 200s-2 and 200s-4 are in their inwardly folded positions (200s-2f and 200s-4f), they facilitate forming a compact shipping module. When wall portion 200s-2 is in its unfolded position (200s-2u), it forms with wall portion 200s-1 a wall component 200s proximate first transverse edge 108, and when wall portion 200s-4 is in its unfolded position (200s-4u), it forms with wall portion 200s-3 a wall component 200s proximate second transverse edge 110.

### C. Unpartitioned Wall Components

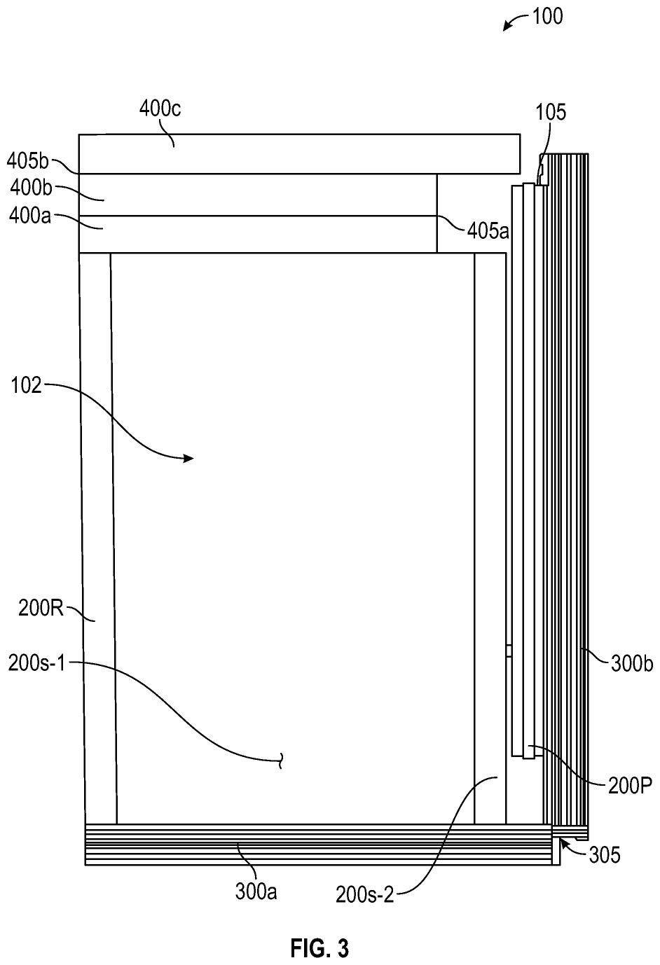

As compared to the two wall components 200 proximate first and second transverse edges 108 and 110, which are partitioned into wall portions, the remaining two wall components 200 proximate first and second longitudinal edges 106 and 116 do not include plural wall portions, but rather each is a single piece structure. However, one of these wall components 200, which is sometimes denominated 200P in this disclosure, and which is located on floor portion 300b proximate first longitudinal edge 106, is pivotally secured to floor portion 300b to permit wall component 200P to pivot about horizontal axis 105 shown in FIG. 3 from a folded position to an unfolded position. Pivotally securing wall component 200P also facilitates forming a compact shipping module 15. The remaining wall component 200, sometimes denominated 200R in this disclosure, is rigidly secured on floor portion 300a proximate second longitudinal edge 116 and abutting the vertical edges of first wall portion 200s-1 and third wall portion 200s-3 proximate to second longitudinal edge 116, as shown in FIG. 2.

### Floor Component (300)

Typically, structure 150 will utilize one floor component 300; thus floor component 300 generally is the full floor of structure 150.

### A. General Description

Floor component 300 has a generally rectangular perimeter and can be fabricated using one or more workpieces 250. The length and width of floor component 300 can vary in accordance with design preference. FIGS. 10 and 11 depict floor component 300 in accordance with the present inventions. The perimeter of floor component 300 is defined by first longitudinal floor edge 117, first transverse floor edge 120, second longitudinal floor edge 119 and second transverse floor edge 118. In particular, (a) first longitudinal floor edge 117, (b) first transverse floor edge 120, (c) second longitudinal floor edge 119 and (d) second transverse floor edge 118 generally coincide with (i.e., underlie) (w) first longitudinal edge 106, (x) first transverse edge 108, (y) second longitudinal edge 116 and (z) second transverse edge 110, respectively, of structure 150.

In the particular embodiment of structure 150 depicted in FIGS. 1B and 2, floor component 300 is approximately 19 feet (5.79 m) by 19 feet (5.79 m).

### B. Floor Partitioning

The floor component 300 is partitioned into floor portion 300a and floor portion 300b. FIG. 2 shows flow portions 300a and 300b in plan view. Each of the floor portions 300a and 300b is a planar generally rectangular structure, with floor portion 300a adjoining floor portion 300b.

Referring to structure 150 shown in FIG. 2, floor portion 300a is fixed in position relative to first wall portion 200s-1, third wall portion 200s-3 and wall component 200R. Floor portion 300a is joined with hinge structures to floor portion 300b, so as to permit floor portion 300b to pivot through approximately ninety degrees (90°) of arc about a horizontal axis 305, generally located as indicated in FIG. 3, proximate the top surface of floor component 300, between a fully folded position, where floor portion 300b is vertically oriented as shown in FIG. 3, and the fully unfolded position shown in FIGS. 2 and 4, where floor portion 300b is horizontally oriented and co-planar with floor portion 300a.

### Roof Component (400)

Typically, structure 150 will utilize one roof component 400; thus roof component 400 generally is the full roof of structure 150.

### A. General Description

Roof component 400 has a generally rectangular perimeter and can be fabricated using one or more workpieces 250. FIG. 1B depicts roof component 400. FIGS. 1, 10 and 11 depict roof component 400 in accordance with the present inventions. The perimeter of roof component 400 is defined by first longitudinal roof edge 406, first transverse roof edge 408, second longitudinal roof edge 416 and second transverse roof edge 410. In particular, (a) first longitudinal roof edge 406, (b) first transverse roof edge 408, (c) second longitudinal roof edge 416 and (d) second transverse roof edge 410 of roof component 400 generally coincide with (i.e., overlie) (w) first longitudinal edge 106, (x) first transverse edge 108, (y) second longitudinal edge 116 and (z) second transverse edge 110, respectively, of structure 150.

The length and width of roof component 400 can vary in accordance with design preference. In the particular embodiment of structure 150 depicted in FIGS. 1, 4 and 5, the length and width of roof component 400 approximates the length and width of floor component 300.

### B. Roof Partitioning

The roof component 400 of structure 150 is partitioned into roof portions 400a, 400b and 400c, shown in FIGS. 1A and 3 when folded, and in FIG. 1B when unfolded. Each of the roof portions 400a, 400b and 400c is a planar generally rectangular structure, with roof portion 400a adjoining roof portion 400b, and roof portion 400b adjoining roof portion 400c.

In the shipping module 15 shown in FIGS. 1A and 3, roof portions 400a, 400b and 400c preferably are accordion folded (stacked), with roof component 400b stacked on top of roof component 400a, and roof component 400c stacked on top of the roof component 400b. As can be appreciated from FIG. 3, roof portion 400a is fixed in position relative to first wall portion 200s-1, third wall portion 200s-3 and wall component 200R. Thus to realize the accordion folded configuration shown in FIG. 3, roof portion 400a is joined to roof portion 400b with hinge structures that are adapted to permit roof portion 400b to pivot through up to one hundred and eighty degrees (180°) of arc about a horizontal axis 405a (see FIG. 3) between the roof fully folded position shown in FIGS. 1A and 3, where roof portion 400b lies stacked flat against roof portion 400a, and the fully unfolded position shown in FIG. 1B. In turn, roof portion 400b is joined to roof portion 400c with hinge structures that are adapted to permit roof portion 400c to pivot through up to one hundred and eighty degrees (180°) of arc about a horizontal axis 405b (see FIG. 3) between the fully folded position shown in FIGS. 1A and 3, where roof portion 400c lies stacked flat against roof portion 400b (when roof portion 400b is positioned to lie flat against roof portion 400a), and the fully unfolded position shown in FIG. 1B.

### Fixed Space Portion Build-Out and Finishing

Referring to FIG. 2, structure 150 includes a fixed space portion 102 defined by roof component 400a (shown in FIG. 3), floor component 300a, wall component 200R, wall portion 200s-1 and wall portion 200s-3. (Fixed space portion 102 is also shown edge-on in the shipping module 100 depicted in FIG. 3). It is preferred that the fixed space portion 102 be fitted out during manufacture with internal components, such as kitchens, bathrooms, closets, storage areas, corridors, etc., so as to be in a relatively finished state prior to shipment of shipping module 100. Also, in the embodiment shown in FIGS. 1 and 2, wall components 200 are fitted during manufacture and prior to shipment with all necessary door and window assemblies, with the enclosure components 155 being pre-wired for electrical needs.

### Enclosure Component Relationships and Assembly for Transport

It is preferred that there be a specific dimensional relationship among enclosure components 155.

Roof portions 400a, 400b and 400c each can be identically dimensioned in the transverse direction. Alternatively, referring to FIG. 3, roof portion 400c can be dimensioned to be larger than either of roof portion 400a and roof portion 400b in the transverse direction to reduce the chances of binding during the unfolding of roof portions 400b, 400c. Further specifics on dimensioning roof portion 400c in the foregoing manner are described in U.S. Non-Provisional application Ser. No. 17/569,962, entitled “Improved Folding Roof Component,” filed on Jan. 6, 2022. In addition, as described in U.S. Non-Provisional patent application Ser. No. 16/786,315, entitled “Equipment and Methods for Erecting a Transportable Foldable Building Structure,” filed on Feb. 10, 2020, issued as U.S. Pat. No. 11,220,816, as well as in U.S. Non-Provisional application Ser. No. 17/569,962 mentioned above, friction-reducing components can be used to facilitate unfolding roof component 400, such as by positioning a first wheel caster at the leading edge of roof portion 400c proximate to the corner of roof portion 400c that is supported by wall portion 200s-2 as roof portion 400c is deployed, and by positioning a second similar wheel caster at the leading edge of roof portion 400c proximate to the corner of roof portion 400c that is supported by wall portion 200s-4 as roof portion 400c is deployed.

Accordingly, in the preferred embodiment each of roof portions 400a and 400b is approximately 4E long and 1.25E wide, whereas roof portion 400c is approximately 4E long and 1.45E wide. In FIGS. 2 and 3, each of floor components 300a and 300b is 4E long; whereas floor component 300a is just over 1.5E wide and floor component 300b is just under 2.5E wide. Wall components 200P and 200R are approximately 4E long, whereas each of wall components 200s in the preferred embodiment is approximately 4E long, less the combined thicknesses of wall components 200P and 200R, as previously indicated.

As shown in FIG. 2, fourth wall portion 200s-4 is folded inward and positioned generally against fixed space portion 102, and second wall portion 200s-2 is folded inward and positioned generally against fourth wall portion 200s-4 (wall portions 200s-2 and 200s-4 are respectively identified in FIG. 2 as portions 200s-2f and 200s-4f when so folded and positioned). The three roof components 400a, 400b and 400c are shown unfolded in FIG. 1B and shown folded (stacked) in FIGS. 1A and 3, with roof component 400b stacked on top of roof component 400a, and roof component 400c stacked on top of the roof component 400b. Wall component 200P, shown in FIGS. 2 and 3, is pivotally secured to floor portion 300b at the location of axis 105 (the general location of which is shown in FIG. 3), and is vertically positioned against the outside of wall portions 200s-2 and 200s-4. In turn, floor portion 300b is vertically positioned proximate fixed space portion 102, with wall component 200P pending from floor portion 300b between floor portion 300b and wall portions 200s-2 and 200s-4.

Sizing the enclosure components 155 of structure 150 according to the dimensional relationships disclosed above yields a compact shipping module 15, as can be seen from the figures. Thus shipping module 15 depicted in FIGS. 1A and 3, when dimensioned according to the relationships disclosed herein using an “E” dimension (see FIG. 2) of 57 inches (144.8 cm), and when its components are stacked and positioned as shown in FIG. 3, has an overall length of approximately 19 feet (5.79 m), an overall width of approximately 8.5 feet (2.59 meters) and an overall height of approximately 12.7 feet (3.87 meters). These overall dimensions are less than a typical shipping container.

Each of the wall, floor and roof components 200, 300 and 400, and/or the portions thereof, can be sheathed in protective film 177 during fabrication and prior to forming the shipping module 15. Alternatively or in addition, the entire shipping module 15 can be sheathed in a protective film. Such protective films can remain in place until after the shipping module 15 is at the construction site, and then removed as required to facilitate enclosure component deployment and finishing.

### Structure Deployment and Finishing

At the building site, shipping module 15 is positioned over its desired location, such as over a prepared foundation; for example, a poured concrete slab, a poured concrete or cinder block foundation, sleeper beams or concrete posts or columns. This can be accomplished by using a crane, either to lift shipping module 15 from its transport and move it to the desired location, or by positioning the transport means over the desired location, lifting shipping module 15, then moving the transport means from the desired location, and then lowering shipping module 15 to a rest state at the desired location. Particularly suitable equipment and techniques for facilitating the positioning of a shipping module 15 at the desired location are disclosed in U.S. Non-Provisional patent application Ser. No. 16/786,315, entitled “Equipment and Methods for Erecting a Transportable Foldable Building Structure,” and filed on Feb. 10, 2020, issued as U.S. Pat. No. 11,220,816. The contents of U.S. Non-Provisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at ¶¶ 126-128 and in connection with FIGS. 11A and 11B thereof.

Following positioning of shipping module 15 at the building site, the appropriate portions of wall, floor and roof components 200, 300 and 400 are “unfolded” (i.e., deployed) to yield structure 150. Unfolding occurs in the following sequence: (1) floor portion 300b is pivotally rotated about horizontal axis 305 (shown in FIG. 3) to an unfolded position, (2) wall component 200P is pivotally rotated about horizontal axis 105 (see FIG. 3) to an unfolded position, (3) wall portions 200s-2 and 200s-4 are pivotally rotated about vertical axes 192 and 194 (shown in FIG. 2) respectively to unfolded positions, and (4) roof portions 400b and 400c are pivotally rotated about horizontal axes 405a and 405b (shown in FIG. 3) respectively to unfolded positions.

After unfolding, the enclosure components 155 are secured together to finish the structure 150 that is shown in FIG. 1. During or after unfolding and securing of the enclosure components 155, any remaining finishing operations are performed, such as addition of roofing material, and making hook-ups to electrical, fresh water and sewer lines to complete structure 150, as relevant here.

The foregoing detailed description is for illustration only and is not to be deemed as limiting the inventions disclosed herein, which are defined in the appended claims.

What is claimed is:

1. An enclosure component for a building structure, the enclosure component having a thickness and comprising:
a first surface layer having a first face and an opposed second face;
a core layer having a first face, an opposed second face, a first edge, an opposed second edge, a third edge separating the first and second edges, and an opposed fourth edge separating the first and second edges; and
a second surface layer having a first face and an opposed second face;
wherein the first and second edges each have a same first linear dimension, and the third and fourth edges each have a same second linear dimension;
wherein the core layer includes a planar vacuum panel assembly with a first face and an opposed second face, the vacuum panel assembly comprising a honeycomb core with two opposed planar surfaces, and with an impermeable sheet bonded to each planar surface of the honeycomb core to seal the honeycomb core, and with air being at least partly evacuated from the honeycomb core prior to sealing to reduce heat transmission across the honeycomb core; and
wherein the second face of the first surface layer is bonded to the first face of the core layer, and the first face of the second surface layer is bonded to the second face of the core layer.

2. The enclosure component of claim 1, wherein the vacuum panel assembly further comprises a planar first foam panel bonded to the first face of the vacuum panel assembly.

3. The enclosure component of claim 2, wherein the vacuum panel assembly further comprises a planar second foam panel bonded to the second face of the vacuum panel assembly.

4. The enclosure component of claim 1, wherein the honeycomb core comprises a structure including a plurality of honeycomb-shaped openings extending through the honeycomb core between the two opposed planar surfaces.

5. The enclosure component of claim 4, wherein the honeycomb-shaped openings define a hollow interior space of the honeycomb core capable of receiving the air therein.

6. The enclosure component of claim 5, wherein the air is at least partially evacuated from the hollow interior space of the honeycomb-shaped openings prior to sealing to reduce the heat transmission across the honeycomb core.

7. The enclosure component of claim 4, wherein the honeycomb core comprises a plurality of elongated elements each defining a honeycomb-shaped configuration.

8. The enclosure component of claim 7, wherein the plurality of elongated elements are bonded to each other in an orientation in which a central longitudinal axis of the elongated elements are aligned in a parallel manner.

9. An enclosure component for a building structure, the enclosure component having a thickness and comprising:
a first surface layer having a first face and an opposed second face;
a core layer having a first face, an opposed second face, a first edge, an opposed second edge, a third edge separating the first and second edges and an opposed fourth edge separating the first and second edges; and
a second surface layer having a first face and an opposed second face;
wherein the first and second edges each have a same first linear dimension, and the third and fourth edges each have a same second linear dimension;
wherein the core layer includes a first planar vacuum panel assembly bonded to a first face of a foam panel and a second planar vacuum panel assembly bonded to a second face of the foam panel opposed to the first face, each of the first and second planar vacuum panel assemblies comprising a honeycomb core with two opposed planar surfaces, and with an impermeable sheet bonded to each of the two opposed planar surfaces of the honeycomb core to seal the honeycomb core, and with air being at least partly evacuated from the honeycomb core prior to sealing to reduce thermal transmission across the honeycomb core; and
wherein the second face of the first surface layer is bonded to the first face of the core layer, and the first face of the second surface layer is bonded to the second face of the core layer.

10. The enclosure component of claim 9, wherein the honeycomb core comprises a structure including a plurality of honeycomb-shaped openings extending through the honeycomb core between the two opposed planar surfaces.

11. The enclosure component of claim 10, wherein the honeycomb-shaped openings define a hollow interior space of the honeycomb core capable of receiving the air therein.

12. The enclosure component of claim 11, wherein the air is at least partially evacuated from the hollow interior space of the honeycomb-shaped openings prior to sealing to reduce the heat transmission across the honeycomb core.

13. The enclosure component of claim 10, wherein the honeycomb core comprises a plurality of elongated elements each defining a honeycomb-shaped configuration.

14. The enclosure component of claim 13, wherein the plurality of elongated elements are bonded to each other in an orientation in which a central longitudinal axis of the elongated elements are aligned in a parallel manner.
